(19) United States
(12) Patent Application Publication
(10) Pub. No.: US 2012/0067983 A1
(43) Pub. Date: Mar. 22, 2012

(54) USE OF AN ALTITUDE-COMPENSATING NOZZLE

(75) Inventor: Ralf Czingon, Saarwellingen (DE)

(73) Assignee: Saar-Metallwerke Gesellschaft mit beschrankter Haftung, Saarbruecken (DE)

(21) Appl. No.: 13/322,190

(22) PCT Filed: May 26, 2010
(86) PCT No.: PCT/DE2010/075042

§ 371 Date: Nov. 28, 2011

(30) Foreign Application Priority Data
May 27, 2009 (DE) 10 2009 025 873.6

(51) Int. Cl. B05B 1/00

(52) U.S. Cl. 239/589

(57) ABSTRACT

The invention relates to the use of one or more nozzles, known as “altitude-compensating” nozzles in the aerospace industry, as outlet nozzles of a feed device for industrial gases to a container during the melting and/or metallurgical treatment of metals.

The invention relates to the use of an altitude-compensating nozzle.

The pig iron produced in a blast furnace contains various undesirable impurities, such as carbon, manganese, silicon, phosphorus and sulphur. These can lead to brittleness, poor forging qualities or an undesirably low melting point.

Inserting a blowing lance into the steelmaking converter in order to introduce industrial gases, in particular oxygen, into the molten pig iron is standard practice. These lances are the basis of various known metallurgical processes, for example the LC or LDAC process. In these processes, the undesired impurities in the molten pig iron are reduced to an acceptable level by way of oxidation and the addition of fluxes. The oxygen, in the form of O₂, is blown selectively onto the molten metal, the oxygen lance releasing the oxygen into the converter at the desired height. As the oxidation progresses, the vertical lance is lowered stepwise further into the converter, above the molten metal.

The oxygen lance consists essentially of a central gas line for the oxygen, surrounded usually by two concentric jacket pipes. These are used for supplying and removing a coolant. The coolant takes up most of the thermal energy absorbed by the lance and lance head—mainly by way of heat radiation and convection—and transports it away from the thermally endangered lance head and out of the converter. The part of the lance head which is directly exposed to the heat is made of copper and/or copper alloys, thus ensuring sufficiently high thermal conductivity. Water is the state-of-the-art coolant currently in use.

The main purpose of an oxygen lance and, in particular, of the lance head, is the directed blowing of oxygen onto and into the molten metal. To this end, the mass flow of oxygen is expanded in this process to the pressure prevailing in the converter, the gas thereby being accelerated within a Laval nozzle, or, more seldom, a bell nozzle, sometimes to several times the speed of sound. Accelerating the oxygen makes it possible to blow it onto and into the melt, where complex metallurgical processes are initiated.

Since the lance is exposed to extreme conditions in the converter atmosphere, the lower part of the lance is subject to wear despite its being cooled. The nozzles, in particular, are affected. If the nozzles are not computed correctly, or if, as a result of process constraints, the oxygen lance is not operated according to the design parameters, the oxygen is under- or over-expanded relative to the converter atmosphere. In the one case, the oxygen jet behaves in an uncontrolled manner which incurs losses, and in the other case, the nozzle geometry is damaged by suction effects and penetration of the converter atmosphere into the inner nozzle geometry.

The main criteria characterising high lance-head quality are:
Long service life or high number of melting operations that can be performed with one and the same head
Uniform blowing properties during the service life of the lance head in order to enhance process stability
Blowing intensity tailored to the process
No leakage of coolant throughout the lance head's service life

Adjustment of the oxygen pressure to the converter atmosphere by way of expansion within the lance head is familiar practice and is prior art.

This is achieved by passing the mass flow of oxygen through at least one head-integrated nozzle with following diffuser. Expansion takes place internally, and the nozzle ends directly in the converter chamber without any additional downstream expansion devices. In other words, the gas expands inside the lance head, the shape of the expansion being defined by a given, outwardly diverging bulge. Mention is made here of the conical Laval nozzle, in particular, which has become established as the standard design.

Computation of the nozzles is based on the ideal case in which, at the nozzle outlet or shortly behind it, the gas introduced into the converter is of ambient pressure.

The term “internal expansion nozzles” is used to describe nozzles in which, at the ideal design point, expansion of the gas takes place (almost) completely within the nozzle geometry. At the theoretically ideal point, the gas at the nozzle outlet lip matches the ambient pressure of the system boundary on the diffuser side.

The gas flows through the nozzle, starting from an overpressure volume, to the outside. In the nozzle, the gas is accelerated and also adjusted to the external pressure conditions.

Typical examples of internal expansion nozzles are, for example, Laval nozzles with straight expansion geometry and “bell nozzles” with rotationally symmetric, parabolic outlet geometries.

Internal-expansion lance-head nozzles—such as Laval nozzles with a conical or parabolic contour—are designed mathematically for an assumed static ambient pressure and an assumed mass flow of oxygen or nozzle admission pressure. This means there is an optimal operating point which is inherent to the operating principle and which corresponds to these underlying general conditions. If the general conditions for which the nozzle was designed change, the nozzle will be operated outside of its specification. For reasons of unpredictable pressure fluctuations within the converter or changes in the mass flow of oxygen, operation of the nozzle outside the ideal design point is, in reality, the rule. Changes in the mass flow of oxygen during the process play an important role in practice.

As the nozzles of known oxygen-lance configurations are designed on the basis of an idealized, static process while, in reality, the processes are dynamic, the lance nozzles are usually underblown or overblown during operation.

Underblowing, in particular (i.e. supplying gas to the nozzles at too low a pressure), considerably influences service life, lance-head wear, the nozzle's geometric stability and hence control of the metallurgical processes. Underblowing causes the gas jet to separate prematurely from the nozzle wall, enabling converter atmosphere to penetrate the interior of the nozzle. Separation of the gas jet from the wall produces undesirable shock waves. The gas experiences a sudden change in conditions such as the Mach number, pressure ratio, density and temperature. With oxygen, for example, the Mach number plunges from an assumed 2.0 to about 0.58. The shock waves cause the flow of gas to constrict, after which it expands again. The gas jet meanwhile behaves in an undesirable and uncontrolled manner, which may prevent optimal metallurgical converter processes and also reduce nozzle efficiency.

In those parts of the diffuser which are not used for expansion, the underpressure zone may produce a suction effect in the area of the nozzle outlet. Damage is then caused by converter atmosphere penetrating into the interior of the diffuser. The nozzles are damaged thereby to the effect that an additional, strongly widening diffuser geometry develops at the end of the original diffuser. In many cases, this has an additional adverse effect and causes further deviation from the desired blowing properties. The reason is the additional widening, which makes the oxygen jet even more uncontrolled and reduces the length of the usable expansion geometry. As a rule, the damage to the shape of the nozzle permanently impairs the blowing properties of the lance head. This also applies to the “operating point” on the basis of which the nozzle design was calculated.

If the volume flow is raised above the ideal design point (overblowing), the gas can no longer expand fully in the nozzle. Uncontrolled compensatory processes may also cause the gas jet to “flutter”.

In this case the gas does expand externally, but this expansion is generally undesirable and is not in keeping with controlled, design-conform conditions.

If the converter pressure is already reached inside the nozzle, the gas flow separates from the wall before reaching the nozzle mouth. The outcome is over-expansion, enabling converter atmosphere to enter the nozzle. This causes undesirable wear, especially in the area of the nozzle mouth.

Undesirable changes in the nozzle geometry have been found to produce a particularly damaging effect. Such changes cause undesirable changes in the gas jet after it exits the diffuser, thus influencing the processes in the converter. Various approaches and methods of preventing changes to the nozzle geometry and protecting the nozzle from wear over a long period of service are therefore being investigated, some of them at great expense.

Among these, for example, are improvements to the channelling and control of the cooling water (DE 696 03 485 T2) with the aim of preventing softening and abrasive wear of the material in the mouth area and thus preventing changes to the nozzle geometry. Another approach, involving the introduction of ceramic rings into the endangered zone (DE 101 02 854 C2), is to protect the endangered zone better with a suitable choice of material.

There is also the approach in which the nozzle is designed right from the start for parameters that do not match the specifications. This represents a departure from the concept of a single ideal operating point. In this case, an attempt is made to find a uniform compromise for the operating points in question.

Since oxygen lances are exposed to extreme conditions, in particular the end facing the metal bath, this part—the “lance head”—is considered to be a part subject to wear. When an old head is worn or damaged, it is removed and a new lance head is welded on. A stronger load on the lance head due to increased wear necessitates a corresponding increase in head-changing frequency.

Over the entire service life of the lance head, various disturbance quantities constitute an obstacle to an ideally controlled process. Imponderabilities and variable parameters during the blowing process lead to undesired effects and their associated impacts, such as increased lance-head wear or sub-optimal process characteristics. Pressure changes and fluctuations, in particular, which result in off-design nozzle operation, play a role here. That leads to the above-described “underblowing” or “overblowing”.

For example, the mass flow of oxygen is reduced while a sub-lance is in use. Sub-lances are used to carry out measurements. During measurement of the various process parameters with a sub-lance, converter operators often reduce the mass flow of oxygen to about 50% in order to protect the sub-lance.

During different refining processes (blowing oxygen into the converter), oxygen flow-volume settings may, in principle, vary.

Since the internal-expansion nozzles used hitherto have a rigid shape, the processes cannot rum optimally.

With oxygen lances of known design, process time, energy and raw materials are not used optimally. These influences result in imponderabilities in the metallurgical processes and in premature nozzle wear, with the consequence of additional costs for maintenance and material.

According to claim 1, the invention provides for the use of one or more nozzles, known as “altitude-compensating” nozzles in the aerospace industry, as outlet nozzles of a feed device for industrial gases to a container during the melting and/or metallurgical treatment of metals.

These altitude-compensating nozzles are known from the aerospace industry. Typical embodiments of such nozzles include, for example, the nozzles generally known as aerospike nozzles, plug nozzles, sera (Single Expansion Ramp Nozzle) nozzles and what are generally known as E-D (Expansion-Deflection) nozzles. In the aerospace industry these nozzles are known as altitude-compensating nozzles because they guarantee adequate thrust at different ambient pressures corresponding to different altitudes and hence the different external pressure conditions during a flight.

Examples of literature in which altitude-compensating nozzles are described are given below:
>Liquid rocket thrust chambers: Aspects of modeling, analysis and design,
Page 437 to page 467
Vigor YANG; Mohammed HABIBALLAH; James HULKA, Michael POPP
ISBN 1-56347-223-6 (2004)
Published by: American Institute of Aeronautics and Astronautics Inc.
Rocket Propulsion Elements—An Introduction to the Engineering of Rockets
Page 70 to page 72
George P. Sutton
ISBN 0-471-52938-9
John Wiley & Sons, Inc. 6th edition (1992)
Elements of Propulsion: Gas Turbines and Rockets, page 189 to page 213
Prof. Jack D. Mattingly
ISBN 1-56347-779-3
AIAA published 2006

Flow behaviour at the nozzle outlet is particularly dependent on the ratio of the ambient pressure to the pressure of the gas flowing out of the nozzle. In the aerospace industry, the ambient pressure ranges widely with the different altitudes during a flight. In this application, by contrast, changes are due mainly to pressure fluctuations in the gas exiting the nozzle and hence in the external:internal pressure ratio.

It has been found that, in this situation, too, the use of altitude-compensating nozzles from the aerospace industry can stabilise flow conditions in the sense that expansion of the gas occurs, at least for the most part, outside the nozzle,

These altitude-compensating nozzles are generally designed as external-expansion nozzles or as internal/external-expansion nozzles (for example, stepped nozzle or extended nozzle). With internal/external-expansion nozzles, the gas flow is first pre-expanded (usually to above Mach 1) by a first nozzle (primary nozzle) and then, in the second step, expanded to the design level by means of an external contour (e.g. the spike of an aerospike nozzle or a flow or shock edge (e.g. E-D nozzle). This means that, irrespective of the operating mode, expansion of the industrial gas to the ambient pressure only takes place, at least for the most part, after the gas has left the nozzle.

As this external expansion is a design-related expansion taking place, for the most part, outside the nozzle, altitude-compensating nozzles have a stabilised flow.

Here, therefore, in contrast to the described overblowing in the familiar Laval nozzles, converter atmosphere does not penetrate the nozzle.

In lance heads of known design, expansion of the oxygen against the ambient pressure of the converter takes place inside at least one internal-expansion nozzle. In the at least one nozzle of the novel lance head, by contrast, this gas expansion—which is characteristic of the blowing-behaviour—against the ambient pressure takes place largely (!) outside the lance-head geometry. That means that in the outlet nozzle, the gas expands, at the most, partially.

In the embodiment according to claim 2, the at least one outlet nozzle is fitted, in the inner area of the outlet aperture, with at least one moulded body which guides the exiting industrial gas to the peripheral area of the at least one outlet nozzle.

To this end, use is made of moulded bodies in the form of additional bodies or additional mould-ons, which channel the gas in not yet fully expanded form out of the nozzle.

The shape of the moulded bodies causes expansion to ensue, in accordance with the design, inside the converter atmosphere. It is thus with intention that adjustment to the converter pressure prevailing at any one time ensues mainly inside the converter and not, as in the case of internal-expansion nozzles, especially Laval nozzles or bell nozzles, within the nozzle geometry.

Whereas, in lances of hitherto existing design, expansion in the converter (i.e. behind the nozzle outlet) corresponds to an operating point that deviates strongly from the targeted operating point for the nozzle design, the nozzles of the invention, with their additional nozzle elements such as deflectors or expansion bodies, are designed not to effect the final pressure adjustment to the converter pressure until outside the geometric limits of the oxygen lance.

Lance heads configured according to the invention can incorporate additional geometries to achieve a directed deflection of the flowing medium. An additional effect is that, compared with a nozzle without an additional geometry of such kind, the medium is compressed. It is thus with intention that the directionally influenced flowing medium expands outside the nozzle after it has exited therefrom.

Such nozzles are configured in a similar manner to nozzles used predominantly in the aerospace industry, including aerospike nozzles, plug nozzles and, in particular, E-D (expansion-deflection) nozzles.

With this invention and the use of additional geometries in the nozzles of an oxygen lance, it proves particularly advantageous that the oxygen adjusts itself to the conditions in the converter. The design makes it possible to operate within a tolerance band including different oxygen pressures without the occurrence of the known overblowing or underblowing effects. It is intended at least to reduce the damage incurred by these effects.

In the embodiment of claim 3, the moulded body protrudes beyond the edge of the outlet nozzle.

This design corresponds to the aerospike nozzles known from the aerospace industry, with the moulded body continuing to shape and orient the expanding gases after they have exited the nozzle.

In the embodiment of claim 4, the moulded body is supported in such a manner that its position can be changed in the outlet direction of the outlet nozzle.

The nozzle flow characteristics can thereby be changed to advantage.

The position change may be effected by re-positioning the moulded body at the start of the process. According to a particularly useful embodiment, the position of the moulded body may also be changed during the course of the process.

According to the embodiment of claim 5, the position of the moulded body can be adjusted by means of an actuator.

The position of the moulded body may thereby be changed by means of an open-loop or closed-loop control system.

In the embodiment according to claim 6, the moulded body is spring-mounted, the positioning of the moulded body being effected by the moulded body's spring mounting, the pressure of the flowing industrial gas and the ambient pressure.

No actuators need to be provided in this ease. Positioning is effected automatically as defined by the spring characteristic and as a function of the process parameters.

In the embodiment according to claim 7, the moulded body has at least one passageway through which some of the industrial gas and/or another gas and/or another material can be output in the outlet direction of the outlet nozzle.

This other material may also be carbon dust, for example, which may be introduced intentionally for specific metallurgical processes.

It has been found that by configuring the moulded body in this way, its length can be reduced in comparison with an aerospike nozzle. For the expanding gas, the medium exiting through the passageway acts as a virtual extension of the moulded body, meaning that the conditions for the expansion of the gas are largely identical or at least similar to the conditions in an aerospike nozzle with a moulded body (spike) of customary length. The virtual extension effect can be explained by the difference in pressure between the medium exiting through the passageway and the expanding gas.

Truncating the moulded body proves beneficial insofar as a moulded body that projects beyond the nozzle's exit orifice is closer to the surface of the molten metal. This is problematic under certain circumstances on account of temperature conditions and the converter atmosphere. Insofar, truncating this moulded body is to advantage.

It is to advantage if a conveying channel or a conveying pipe is attached or can be attached to the passageway so that industrial gases or materials such as carbon particles can be selectively supplied through the passageway.

The matter (materials or gases) supplied via the passageway can thereby be advantageously separated from the other matter exiting from the nozzle.

In the embodiment according to claim 8, cooling channels are assigned to the outlet nozzles, which extend outside of the nozzles along the external contour of the outlet nozzles at least substantially perpendicular to the direction of the outlet-nozzle flow, a coolant being conveyable through the cooling channels and the external contour of the outlet nozzles having not an axially symmetrical but an elongated cross-section the longitudinal direction of which is in the flow direction of the coolant.

The right to file a divisional application for this measure of claim 8 is explicitly reserved, in which, for this feature relating to the design of the external contour of the outlet nozzle, protection is requested irrespective of the fact that the nozzle is, to use the name given it in the aerospace industry, an “altitude-compensating” nozzle. As is evident, cooling can also be improved in conventional nozzles by designing the external contour of the nozzle according to the measure of claim 8.

The cooling channels are built into the solid material of the external contour of the outlet nozzles. The adapted external contour of the outlet nozzles with the elongation in the coolant-flow direction proves insofar beneficial as substantially more efficient cooling is effected. A larger amount of coolant can be conveyed on account of the lower flow resistance. In addition, better coolant flow can be realised. For one, assuming there are at least two nozzles, the flow cross-section between the nozzles can be increased and configured to be more flow-favourable. Whereas flow velocity between the nozzles increases sharply with a round configuration, flow velocity decreases sharply behind the nozzles as seen in flow direction. This considerably reduces cooling performance in the slow flow zone and can, under certain circumstances, lead to a reduction in the durability of the nozzle shell. In addition, there is a possibility of water converting into the steam phase at these locations. This can likewise have undesirable consequences.

The described adaptation of the external contour of the nozzles makes it possible to dissipate a greater amount of heat energy. By virtue of the cross-section being elongated in the water's flow direction, the flow of water around the outside of the nozzle is improved because eddies are reduced or prevented. Cooling is thereby rendered more efficient.

In the embodiment of claim 9, the moulded body has at least one cooling channel passing through its connection with the material of the external contour of the outlet nozzle and through its interior.

It proves to be of advantage here that the moulded body, too, is cooled. The moulded body has at least one connection with the material of the outer contour of the outlet nozzle, via which the moulded body is anchored in the interior of the outlet nozzle. Via a cooling channel in this at least one connection and an extension of the cooling channel through the interior of the moulded body, the moulded body can advantageously be cooled directly from the interior.

In the embodiment according to claim 10 the moulded body has, in the elongated cross-section of the outlet nozzle, a first connection with the material of the external contour of the outlet nozzle at the one short side of the cross-section and another connection at the opposite side, the cooling channel supplying coolant to the moulded body via the first connection and discharging it via the other connection.

It is to advantage here that the cooling channel in the moulded body, together with the supply and discharge sections, runs in flow direction. This, in turn, makes for low flow resistance during direct cooling of the moulded body, advantageously enabling the cooling system to be designed with a high level of efficiency.

This invention is particularly suitable for use in electric arc furnaces (EAF). In these furnaces, the jet exiting the lance (usually oxygen) has hitherto been bundled by simultaneously discharging a shroud of natural gas around the outflowing oxygen. Ignition of the shroud of natural gas results in expansion and increases coherence in the oxygen jet. In this invention and the jet bundling it provides for, the kinetic energy is concentrated and the jet bundled in such a way as to enable the industrial gas to penetrate the melt without need of a shroud gas of the kind mentioned.

Some explanations concerning the use as per this invention of altitude-compensating nozzles are given below.

The properties of E-D nozzles, in particular, offer additional possibilities of optimising lance-blowing by means of suitably adapted “operating modes”. E-D nozzles are characterised by two different flow modi. These are referred to as “open” and “closed”.

In closed-wake mode the exiting gas fills the entire nozzle and operation resembles that of a bell nozzle without height compensation. If the ratio between the oxygen pressure at the smallest cross-section of the exit and the converter pressure increases and reaches a specific value—the design point—the behaviour of the expanding gas changes. The gas flow within the nozzle contour is annular, and it leaves the inner nozzle contour not yet fully expanded. In this mode, referred to as “open wake”, the stream of gas obtains the already-described compensation characteristic: the converter pressure itself develops a contour made up of different gas states, and this contour defines the form of the expansion. Compared with the nozzles used hitherto, such as the conical Laval nozzles, this leads to an almost ideal expansion characteristic over a considerably wider range in the ratio between internal pressure in front of the nozzle and external pressure.

Unlike the prior art, various requirements in metal-processing converters and other (large) metallurgical vessels can hereby be taken into account. Designing blowing lances according to the invention can thus have far-reaching positive influences on the processes in converters and their operation. Processes with different oxygen streams and yet a comparatively high efficiency become possible.

Suitable nozzle design furthermore saves raw materials and energy, positively influencing follow-up costs and the environment.

Use in vacuum processes for treating steel, which are operated at very low pressure, is also to advantage (for example in VOD (Vacuum Oxygen Decarburisation) processes). Since fluctuations in the operating-pressure ranges are sometimes encountered here (vacuum, e.g. 0.01 bar-0.001 bar), an oxygen-lance head with an altitude-compensating nozzle may contribute substantially to process safety, as this class of nozzles is much more tolerant towards internal/external pressure differences.

On account of the large pressure difference between internal pressure (in front of the nozzle) and converter pressure, prior-art nozzle designs have given rise to very unpracticable nozzle lengths. Altitude-compensating nozzles do not have this problem because expansion takes place, at least for the most part, outside of the nozzle geometry. In addition, a plurality of nozzles of different design and flow rate may be replaced by a single nozzle.

Altitude-compensating nozzles are known from experimental space travel projects. There they are used over an enormous range of different external pressure zones. Examples of such projects include the SSTO (Single Stage To Orbit) project using aerospike nozzles and the STERN project (Static Test Expansion deflection Rocket Nozzle) using E-D nozzles. These nozzles are used because they have a self-adapting characteristic with respect to the external pressure, and are able to master vastly differing pressure conditions—from near-ground-level all the way up into orbit—with a single stage.

This invention is based on the realization that nozzles of this kind can be used in the field of steel production. The outcome is that, for steel production and especially for refining with oxygen lances, nozzles are used with which the gas, at least for the most part, undergoes external expansion.

Compatible connection to existing oxygen lances is advantageously achieved with a design in which water flows on the outside and gas on the inside. This is usually the case in currently used oxygen blowing lances. When the lance head needs changing, it can then easily be replaced by a lance head according to this invention.

A stream of coolant, e.g. water, flows through the lance in the two outer pipe areas. Oxygen flows through the central pipe in the lance to the lance head at the end, where at least one nozzle is usually located through which the gas exits into the converter.

The cooling-water and gas areas may be arranged differently, however, if an expedient embodiment makes this possible.

Below, two typical embodiments of altitude-compensating nozzles are described in connection with this invention.

1. Oxygen Lance Heads with Aerospike(s)

The gas is compressed as a result of the narrowing in the cross-sectional area, and hence the smaller flow cross-section, of the line leading from the gas-carrying pipe into the nozzle inlet. As it passes within an annular contour from the nozzle inlet to the narrowest part of the nozzle, the gas is compressed further on account of the limitation set by the nozzle aperture and of the centrally mounted aerospike. The nozzle surrounds the inner part of the aerospike, which is part of the compression cross-section.

The aerospike may be anchored in various ways. It may, for example, be anchored in the nozzle pipes by means of laterally attached brackets, or also to another part of the oxygen lance or lance head. Anchoring the moulded body on the gas-inlet side in a disc with openings for the passage of gas also reflects industrial practice. Yet another alternative consists in moulding the spike onto an already-existing component belonging to the basic geometry of a lance head.

At the end of the compression path, the gas is directed to the aerospike contour at an angle to be specified. From there, the gas expands into the converter and is guided by the aerospike outside of the lance head. Since an ideal moulded body is by design too long for practicable operation, it may be truncated. This lowers the efficiency. However, for an appropriate truncation the losses are acceptable, because the missing edges are simulated by complex flows to give an ideal contour made up of gas and complex shock layers.

The moulded body is divided essentially into an inner and an outer area. In the inner area, the gas is guided according to the configuration, adapted to the pressure and/or exit surface area as defined by the nozzle design and made to exit from the lance head. The mass flow is steered here against a nozzle geometry outside of the lance head. The jet may have been accelerated already to a Mach number greater than 1 by an upstream expansion contour. Further adaptation of the jet is usually not yet concluded. In aerospike nozzles, the point of maximum compression is very close to the geometric boundary with the converter chamber.

The gas expands directly against the ambient pressure, the form of the expansion being defined by a partially external geometry.

Expansion via a design-related external lance-head contour offers the advantage that the expansion can be controlled over a wide range of pressure conditions and kept closer to the ideal characteristic than is possible with a lance head of known design under the same conditions. In connection with use according to this invention, the “altitude compensation” effects a “self-adaptation” in the sense that a better process characteristic is obtained over a wider range of process parameter values. This results additionally in higher efficiency outside of the design point.

The external geometry may have different contours.

In a rotationally symmetrical variant, conical or optimized, complex parabolic shapes that are usually determined in numerical/mathematical processes are the most common forms of embodiment. The ideal length at which only small efficiency losses are incurred may also be reduced, thereby creating truncated geometries.

Despite sometimes greater reductions in the length of the geometry projecting into the converter chamber, the remaining stumps are able to develop their effect. This is because the missing areas are partially imitated by the formation of gas flows, these areas themselves acting as a continuation of the nozzle contour beyond the end of the nozzle.

The mouth area of the inner nozzle may be executed, for example, as an annular passageway or as a plurality of directional exit apertures. If the external geometry is truncated, flow geometries may optionally be attached in the axial direction of the nozzle. These flow geometries may take the form of one or a plurality of through holes which support the formation of desired flows. If the exit is in the centre of the geometry, an additional nozzle of this kind is referred to as “base bleeding”.

Nozzle geometries required for the inventive embodiment of a lance head may, depending on the type of embodiment, be moulded directly onto the lance head and may also be of multicomponent design. The nozzle geometries may be connected, using a base member, to the lance head by joining techniques such as insertion, adhesion or welding. In ₜhe case of a multicomponent embodiment, different materials may be used. For example, copper may be used for the base member, which may contain the inner nozzle area, and ceramic for the conical outer nozzle area.

2. Oxygen-Lance Heads with E-D Nozzle(s)

Oxygen lances with E-D nozzles are characterised by nozzles having a deflector located in the oxygen stream. Design-wise, an E-D nozzle resembles a bell nozzle with a central moulded body to which the deflector is attached. The deflector generally ends before, i.e. upstream of, the nozzle exit edge.

The deflector guides the oxygen flow, as a function of the geometric shape of the centrebody, against the side walls of the nozzle. The nozzle can operate in two different states, known as “open wake” and “closed wake”, depending on the ratio of the pressure in front of the nozzle to the converter pressure. Whereas in the “open wake” mode expansion is largely external, with compensation for different pressure conditions, the “closed wake” mode resembles an internal-expansion nozzle.

However, the flow of gas along the nozzle walls is stronger than in an internal-expansion nozzle. This increases the nozzle's durability because the aggressive converter atmosphere cannot damage the exit edge so readily as in lance-head designs with known expansion geometries.

This effect is caused by the deflecting influence of the centrebody. By virtue of the special shape of the centrebody in the area facing the nozzle exit and, in particular, in the area of the narrowest cross-section, it is possible to develop nozzles that take the many requirements concerning both the various process parameters in metallurgical processes and the durability of the parts better into account than was possible with prior-art designs.

An embodiment of the invention is shown in the drawings, where

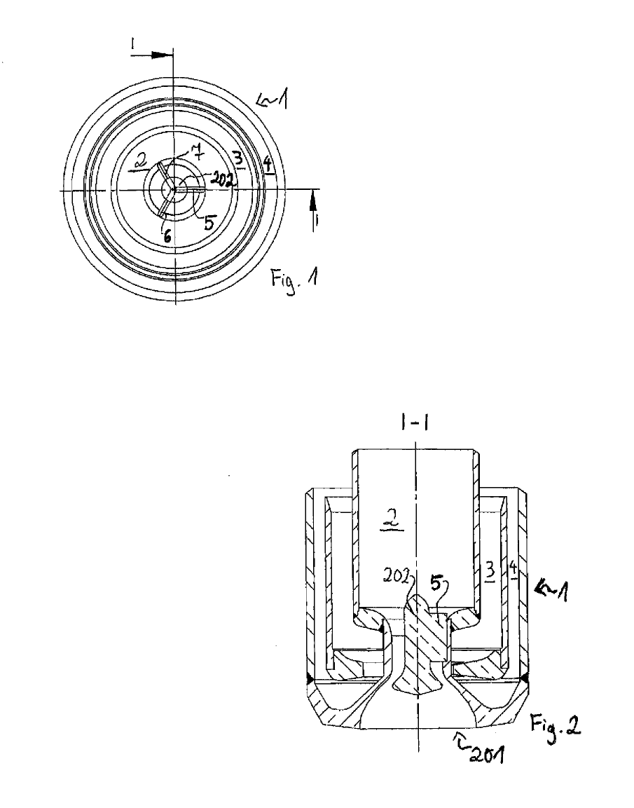

FIGS. 1-4: show different views of a lance head with an E-D nozzle and of a moulded body (pintle) in the E-D nozzle

FIGS. 5-8: show different views of a lance head with an aerospike nozzle and of the moulded body (spike) in the aerospike nozzle,

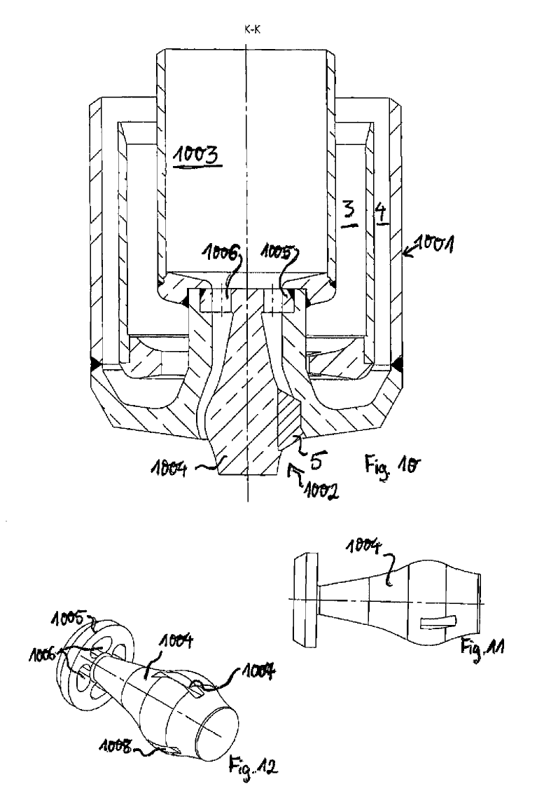

FIGS. 9-12: show different views of a lance head with another aerospike nozzle and of the moulded body (spike) in the aerospike nozzle,

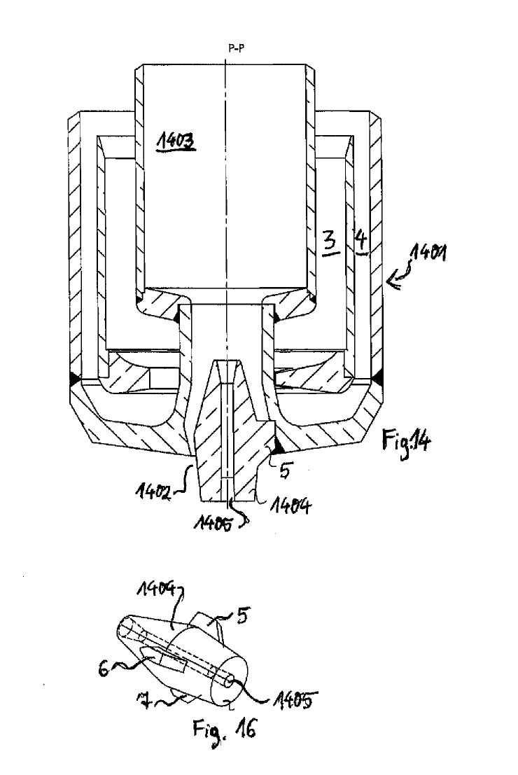

FIGS. 13-16: show different views of a lance head with another aerospike nozzle and of the moulded body (spike) in the aerospike nozzle,

FIGS. 17-20: show different views of a lance head with another E-D nozzle and of the moulded body (pintle) in the E-D nozzle,

FIGS. 21-25: show different views of a lance head with another E-D nozzle and of the moulded body (pintle) in the E-D nozzle,

FIG. 26: shows a moulded body (spike) of an aerospike nozzle,

FIG. 27: shows an embodiment for the use of a nozzle according to this invention in an electric arc furnace,

FIG. 28: shows a lateral section through a nozzle,

FIG. 29: shows a top view of the nozzle of FIG. 28 in flow direction

FIG. 30: shows a lateral section through another embodiment of a nozzle,

FIG. 31: shows a top view of the nozzle of FIG. 30 in flow direction

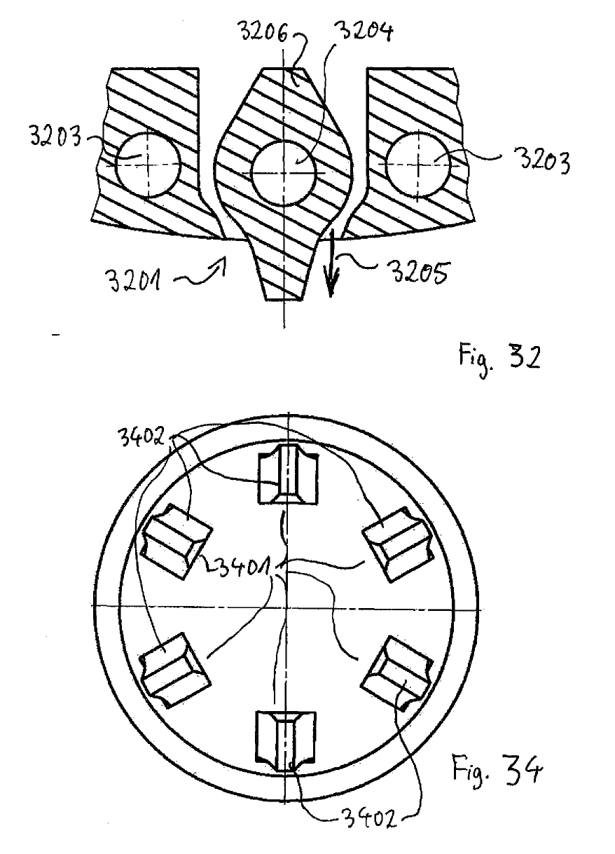

FIG. 32: shows a lateral section through a nozzle with a moulded body and cooling channels

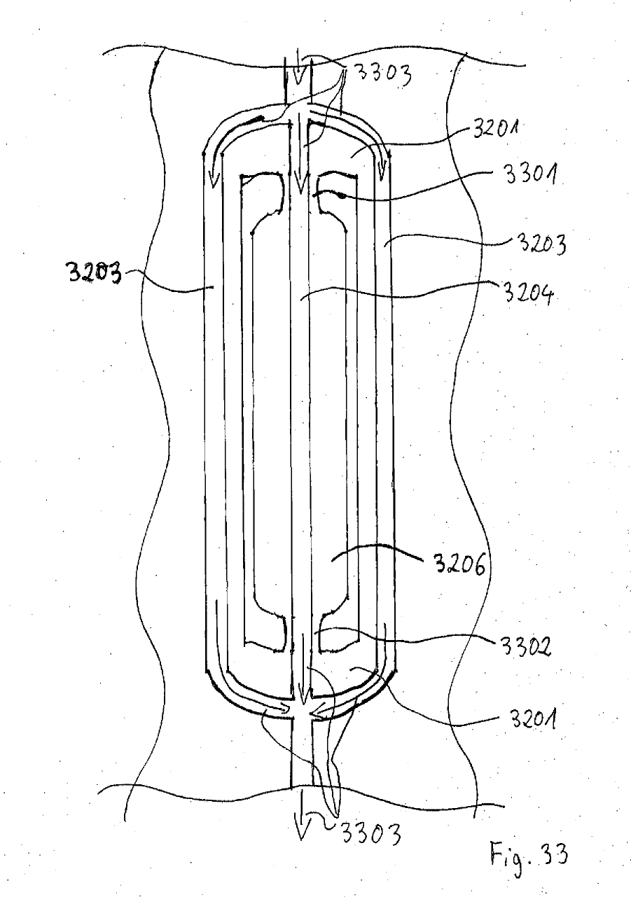

FIG. 33: shows the nozzle of FIG. 32 in a sectional view from below

FIG. 34: shows an annular arrangement of outlet nozzles with moulded bodies in a view from below.

FIG. 2 shows a lateral section through a lance head 1 with an E-D nozzle 201. FIG. 1 shows the corresponding view of the lance head 1 from above.

In its interior, the lance head 1 has a conveying channel 2 through which the industrial gas is conveyed towards the E-D nozzle 201, where it exits. The flow and return components 3 and 4 respectively of a cooling circuit are also visible. The purpose of this cooling circuit 3, 4 is to circulate water therein and thereby cool the lance head.

The E-D nozzle 201 is seen to have a moulded body 202 located within it, this having, for example, three anchoring elements 5, 6, 7 supported on a shoulder of the E-D nozzle 201. The moulded body 202 is held in position by these.

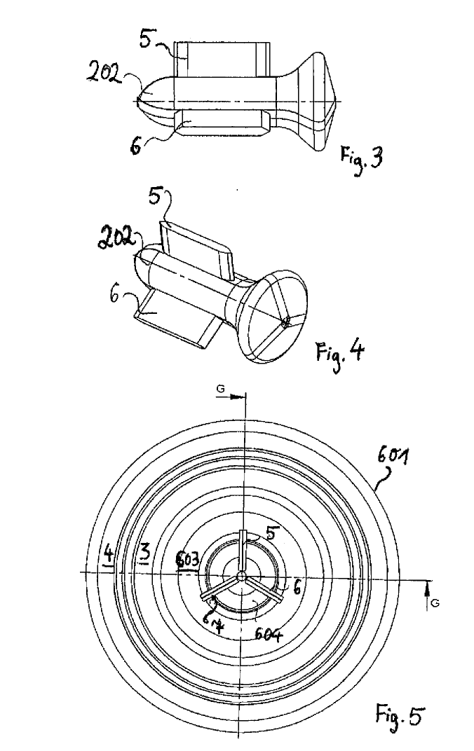

FIGS. 3 and 4 show the moulded body 202 from different perspectives. The anchoring element 7 is obscured in these drawings, whereas the anchoring elements 5 and 6 are visible.

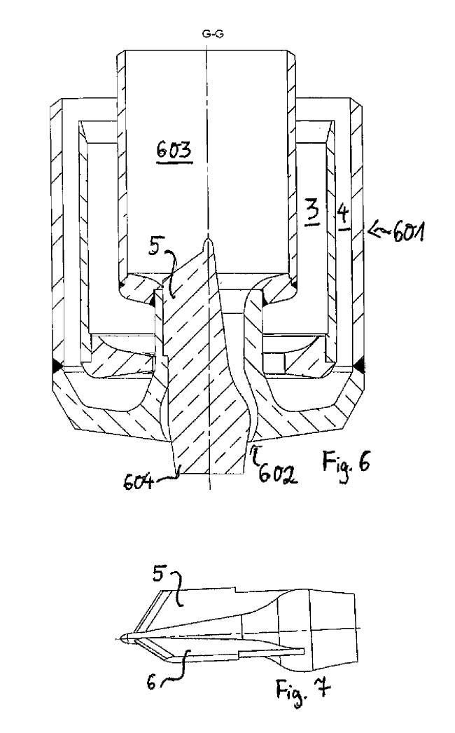

FIG. 6 shows a lateral section through a lance head 601 with, by way of example, an aerospike nozzle 602. FIG. 5 shows the corresponding view of the lance head 601 from above.

In its interior, the lance head 601 has a conveying channel 603 through which the industrial gas is conveyed towards the aerospike nozzle 602, where it exits. The flow and return components 3 and 4 respectively of a cooling circuit are also visible. The purpose of this cooling circuit 3, 4 is to circulate water therein and thereby cool the lance head.

The aerospike nozzle 602 is seen to have a moulded body 604 located within it, this having, for example, three anchoring elements 5, 6, 7 supported on a shoulder of the aerospike nozzle 602. The moulded body 204 is held in position by these.

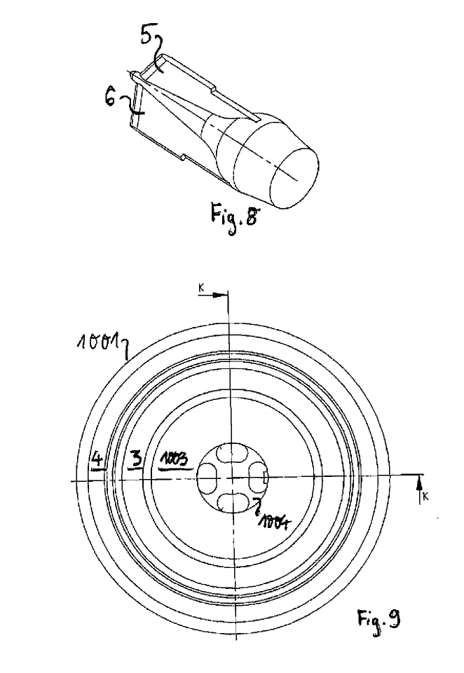

FIGS. 7 and 8 show the moulded body 604 from different perspectives. The anchoring element 7 is obscured in these drawings, whereas the anchoring elements 5 and 6 are visible.

FIG. 10 shows a lateral section through a lance head 1001 with an aerospike nozzle 1002. FIG. 9 shows the corresponding view of the lance head 1001 from above.

In its interior, the lance head 1001 has a conveying channel 1003 through which the industrial gas is conveyed towards the aerospike nozzle 1002, where it exits. The flow and return components 3 and 4 respectively of a cooling circuit are also visible. The purpose of this cooling circuit 3, 4 is to circulate water therein and thereby cool the lance head.

The aerospike nozzle 1002 is seen to have a moulded body 1004 located within it, which has three anchoring elements 5, 6, 7. These anchoring elements 5, 6, 7 serve to support the lower part of this moulded body 1004 against the edge of the aerospike nozzle 1002. A support plate 1005 is also visible, which has passageways 1006 for the passage of industrial gas. This plate 1005 is supported on a shoulder of the aerospike nozzle 1002, thereby holding the moulded body 1004 in position.

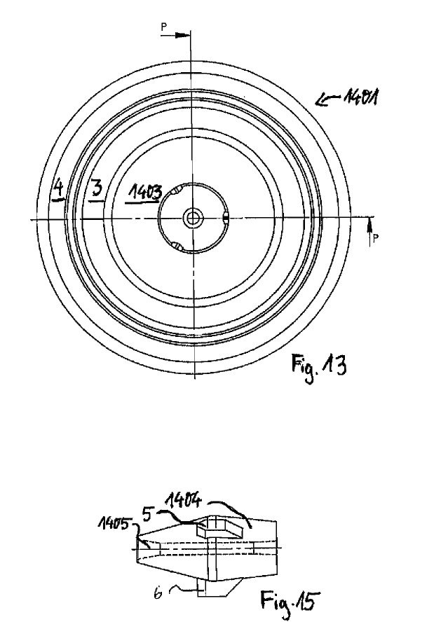

FIGS. 11 and 12 show the moulded body 1004 from different perspectives. The anchoring elements 5, 6, 7 are inserted into the slots 1007, 1008 for these anchoring elements 5, 6, 7,

FIG. 14 shows a lateral section through a lance head 1401 with an aerospike nozzle 1402. FIG. 13 shows the corresponding view of the lance head 1401 from above.

In its interior, the lance head 1401 has a conveying channel 1403 through which the industrial gas is conveyed towards the aerospike nozzle 1402, where it exits. The flow and return components 3 and 4 respectively of a cooling circuit are also visible. The purpose of this cooling circuit 3, 4 is to circulate water therein and thereby cool the lance head.

The aerospike nozzle 1402 is seen to have a moulded body 1404 located within it, this having, for example, three anchoring elements 5, 6, 7 supported on a shoulder of the aerospike nozzle 1402. The moulded body 1404 is held in position by these.

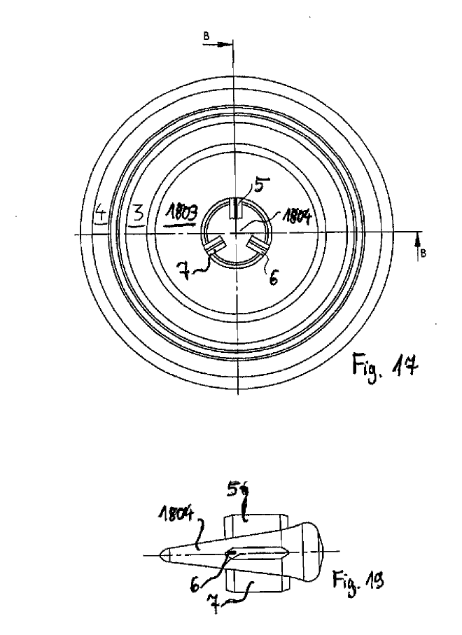

FIGS. 15 and 16 show the moulded body 1404 from different perspectives. The anchoring element 7 is obscured in FIG. 15, whereas the anchoring elements 5 and 6 are visible.

The moulded body 1404 is seen to have a passageway 1405 through which the industrial gas may be channelled. The industrial gas also exits through the aerospike nozzle 1402. This passageway 1405 proves particularly useful in the case of a truncated moulded body 1402 because it influences the flow characteristic of the exiting gas in such manner that the gas, after exiting the aerospike nozzle, flows along this jet issuing from the opening 1405. Assuming a suitable design, the exiting gas jet may, in some cases, develop advantageously as a result.

It is also possible to channel other substances, such as other gases, carbon particles, carbon dust or the like, through a central passageway 1405 in the moulded body 1404. Metallurgical processes can thereby be influenced beneficially.

It is evident that a passageway of this kind may also be provided in a moulded body within an E-D nozzle.

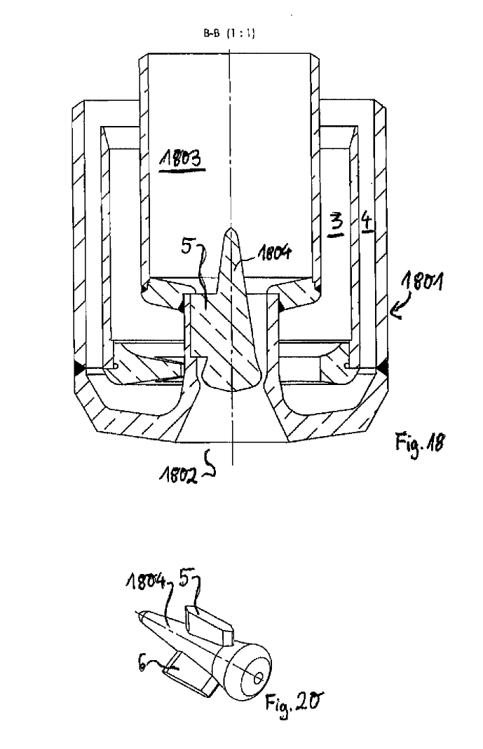

FIG. 18 shows a lateral section through a lance head 1801 with an E-D nozzle 1802. FIG. 1 shows the corresponding view of the lance head 1801 from above. In contrast to the illustration in FIG. 2, this nozzle is not a bell nozzle. Instead, the basic geometry is that of Laval nozzle.

In its interior, the lance head 1801 has a conveying channel 1803 through which the industrial gas is conveyed towards the E-D nozzle 1802, where it exits. The flow and return components 3 and 4 respectively of a cooling circuit are also visible. The purpose of this cooling circuit 3, 4 is to circulate water therein and thereby cool the lance head.

The E-D nozzle 1802 is seen to have a moulded body 1804 located within it, which has three anchoring elements 5, 6, 7 supported on a shoulder of the E-D nozzle 1802. The moulded body 1804 is held in position by these.

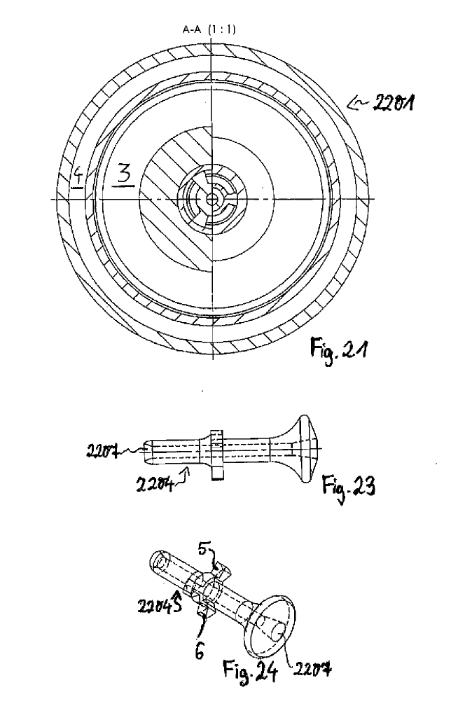

FIGS. 19 and 20 show the moulded body 1804 from different perspectives. The anchoring element 7 is obscured in FIG. 20, whereas the anchoring elements 5 and 6 are visible.

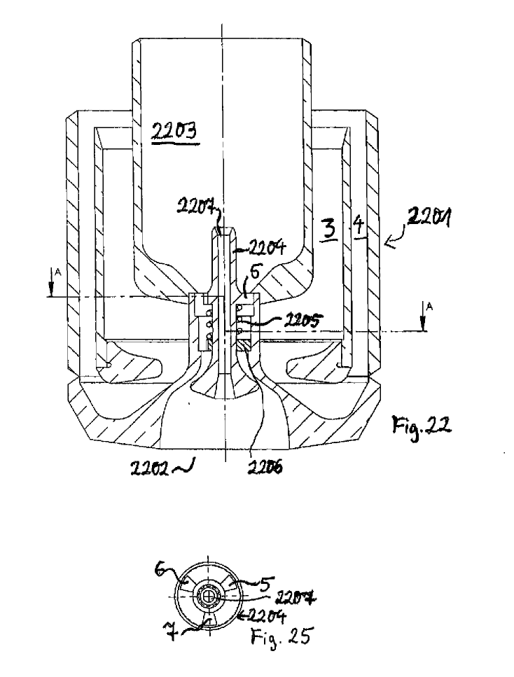

FIG. 22 shows a lateral section through a lance head 2201 with an E-D nozzle 2202. FIG. 21 shows the corresponding view of the lance head 2201 from above.

In its interior, the lance head 2201 has a conveying channel 2203 through which the industrial gas is conveyed towards the E-D nozzle 2202, where it exits. The flow and return components 3 and 4 respectively of a cooling circuit are also visible. The purpose of this cooling circuit 3, 4 is to circulate water therein and thereby cool the lance head.

The E-D nozzle 2202 is seen to have a moulded body 2204 located within it, which has three anchoring elements 5, 6, 7 supported by means of a spring mounting 2205 on a shoulder 2206 of the E-D nozzle 2202. The moulded body 2204 is thereby held elastically in position. The flow characteristic of the E-D nozzle 2202 can be varied beneficially by means of this spring mounting.

It is also evident that the moulded body 2204 has a passageway 2207, which has already been described in connection with FIGS. 13 to 16 for a spike in an aerospike nozzle.

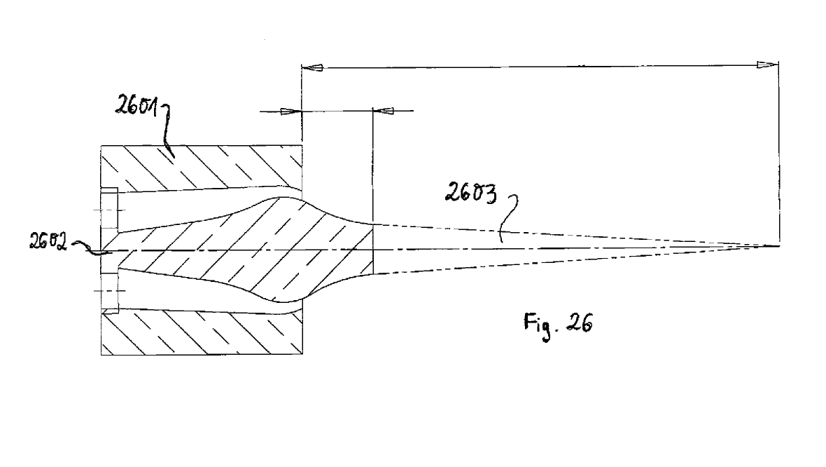

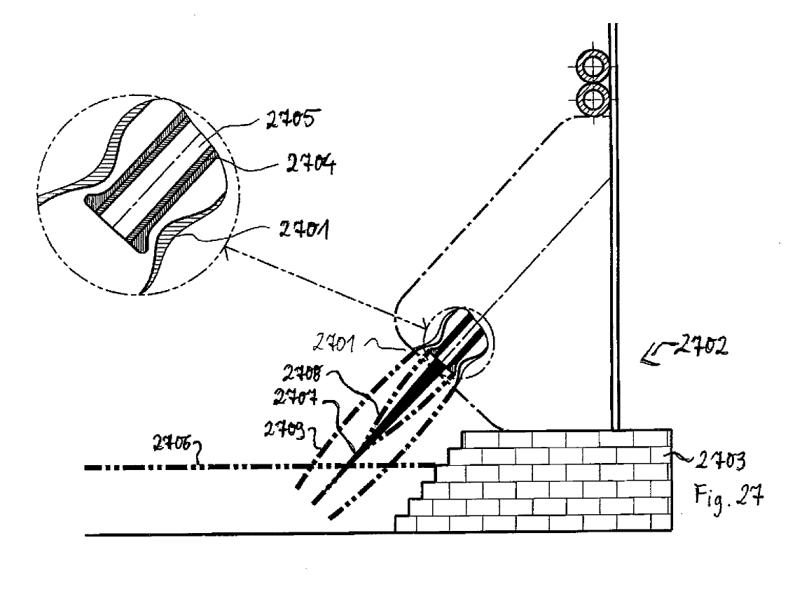

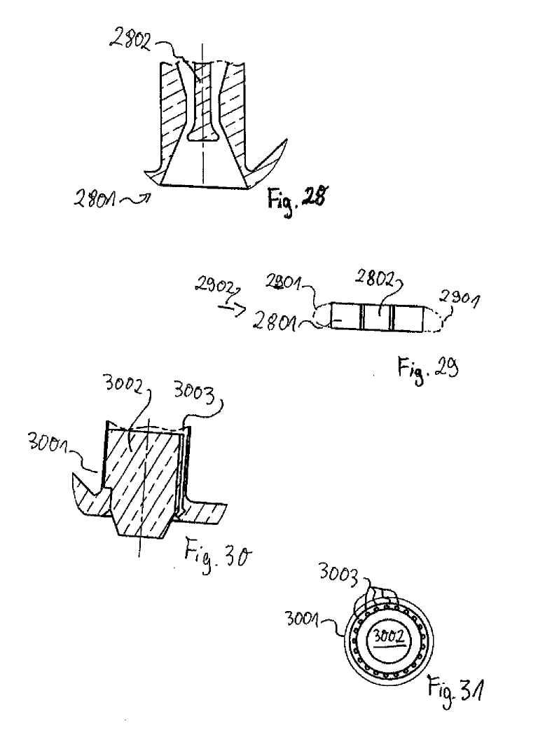

FIGS. 23, 24 and 25 show the moulded body 2204 from different perspectives.

FIG. 26 shows a moulded body (spike) 2602 of an aerospike nozzle 2601. The full length of the moulded body (spike) 2602 is shown by the dashed extension 2603. It has been found that an aerospike nozzle with a full-length spike has an optimal flow characteristic. However, it has also been found that an approximately optimal flow characteristic can still be obtained if the spike is appropriately truncated.

If, in this invention, the moulded body (spike) 2602 were to extend too far, the tip of the moulded body would come correspondingly close to the metal bath. This would mean exposing it to a high temperature without being able to cool the spike right to its tip.

Particularly for the described application, it has proved beneficial to truncate the moulded body. In spite of this, advantageously, the form of the expansion of the exiting gases is largely maintained.

If necessary, the moulded body 2602 may be provided with a central passageway of the kind already described in connection with FIGS. 13 to 16.

FIG. 27 shows an embodiment for the use of a nozzle 2701 according to this invention in an electric furnace 2702 with a refractory lining 2703. Electric furnaces of this kind are also known as electric arc furnaces or EAF. Steel scrap is melted in these ovens so that it can be used again in new steel. Arcs are struck by means of direct or alternating current between one or a plurality of electrodes and the charge to be melted.

The nozzle 2701 is seen to have a moulded body 2704 with a central passageway 2705.

The surface 2706 of a metal bath is also visible. A central jet 2707 exits the nozzle 2701. The lines 2708 and 2709 describe the contour curves of the gas exiting from the nozzle 2701. Thanks to the bundled gas output, it is able to advantageously penetrate the surface 2706 of the metal bath and pass into the metal bath. By virtue of the depth reached, metallurgical processes are favourably influenced. The gas jet may also be used to promote the melting of scrap positioned in front of the nozzle.

In the embodiment shown, the central jet 2007 consists of carbon particles. The limiting curves 2708 and 2709 indicate that, by virtue of the nozzle characteristic, the gas is more coherent than is the ease with the nozzle designs used hitherto. As a result, it may be possible to dispense with the hitherto routine practice of using an ignited mixture of natural gas and oxygen as shroud gas.

FIG. 28 shows a lateral section through a nozzle 2801. Here again, a moulded body 2802 is visible. Unlike the nozzles illustrated so far, the nozzle 2801 only shows mirror symmetry relative to the central axis, which passes centrally through the moulded body 2802. The nozzle 2801 does not show rotational symmetry.

FIG. 29 shows the nozzle 2801 of FIG. 28 as viewed from above in flow direction. It is evident that the nozzle 2801 has an elongated (that is, rotationally asymmetric) profile in the transverse direction. This profile may be of rectangular section. It is apparent from the lines 2901 that the edges of this profile may also be rounded.

This proves to advantage for cooling the nozzle 2801. The arrow 2902 indicates the flow direction of a coolant (water) which flows around the nozzle during operation. On account of the profile being elongated in the flow direction of the coolant, it is more flow-enhancing and an enlarged flow cross-section is obtained. The coolant shows a better flow characteristic as a result, and the nozzle 2801 is cooled more efficiently.

It is evident that this nozzle profile is suited for use not only in the E-D nozzle shown but also in aerospike nozzles.

Apart from being suitable for such nozzle types as are connected with this invention, this profile is also suitable for conventional nozzles, because in these, too, efficient cooling is important. Reference was already been made to this at the beginning of the introductory part of the specification in connection with the right to file a separate divisional application focused on this aspect.

FIG. 30 shows a lateral section through another embodiment of a nozzle 3001. Here again, a moulded body 3002 is visible. Instead of an annular nozzle opening, the nozzle has a plurality of openings 3003 located along the external periphery of the nozzle 3001.

This is again visible in FIG. 31, which is a top view of the nozzle in flow direction. With this type of nozzle, the industrial gas exits through the openings 3003. These may also be designed, for example, as Laval nozzles in order to achieve an “incomplete” pre-expansion. The jet does not undergo complete and directional expansion until this is shaped by the moulded body 3002,

FIG. 32 shows a lateral section through a nozzle 3201 with a moulded body 3202 and cooling channels 3203, 3204. This may be an outlet nozzle that is shown in FIG. 33 from below. That means that the external contour of this outlet nozzle is elongated in the flow direction of the cooling channels 3203, 3204. This elongation is not visible in the illustration of FIG. 32 because the illustration of FIG. 32 shows a section perpendicular to the direction of this elongation.

It can be seen that the cooling channel 3203 extends outside of the outlet nozzle 3201 along the external contour, at least substantially at right angles to the flow direction of the outlet nozzles 3201. The arrow 3205 shows this flow direction of the outlet nozzles. By this direction is meant the flow direction of the gas or of the particles exiting via the outlet nozzle 3201. A coolant can be conveyed through the cooling channels 3203.

Elongating the external contour of the outlet nozzles 3201 makes for a better coolant flow characteristic.

The moulded body 3206 has at least one cooling channel 3204 passing through its connection with the material of the external contour of the outlet nozzle 3201 and through its interior.

In the sectional view seen from below in FIG. 33, it is evident that the moulded body 3206 has a first connection 3301 with the material of the external contour of the outlet nozzle 3201 at the one short side of the cross-section. The moulded body 3206 also has a second connection 3302 at the opposite side. It is evident that the cooling channel 3204 enters the moulded body 3206 via the first connection 3301 and leaves it via the second connection 3302.

The arrows 3303 indicate the coolant's flow direction.

The advantage here is that the cooling channel 3204 within the moulded body 3206 runs in the flow direction of the coolant and that the coolant within the moulded body 3206 accordingly has a good flow characteristic.

FIG. 34 shows an annular arrangement of outlet nozzles 3401 with moulded bodies 3402 in a view from below.

Within the scope of the aforementioned and described invention it may also prove expedient to protect the moulded body against the hot atmosphere by means of a metallic or ceramic coating. Separate, active cooling of the moulded body may thereby be rendered unnecessary. This applies to all the embodiments described in connection with this application.

1. Use of one or more nozzles (201, 602, 1002, 1402, 1802, 2202, 2601, 2701), known as “altitude-compensating” nozzles in the aerospace industry, as outlet nozzles of a feed device (1, 601, 1001, 1401, 1801, 2201) for industrial gases to a container during the melting and/or metallurgical treatment of metals (2706).

2. Use according to claim 1, wherein the at least one outlet nozzle (201, 602, 1002, 1402, 1802, 2202, 2601, 2701) is fitted, in the inner area of the outlet aperture, with at least one moulded body (202, 604, 1001, 1404, 1804, 2204, 2602, 2704) which guides the exiting industrial gas to the peripheral area of the at least one outlet nozzle (201, 602, 1002, 1402, 1802, 2202, 2601, 2701).

3. Use according to claim 2, wherein the moulded body (604, 1004, 1404, 2602) protrudes beyond the edge of the outlet nozzle (602, 1002, 1402, 2601).

4. Use according to claim 2, wherein the moulded body (2204) is supported in such a manner that its position can be changed in the outlet direction of the outlet nozzle.

5. Use according to claim 4, wherein the position of the moulded body can be adjusted by means of an actuator.

6. Use according to claim 4, wherein the moulded body (2204) is spring-mounted (2205), the positioning of the moulded body being effected by the spring mounting (2205) of the moulded body (2204), the pressure of the flowing industrial gas and the ambient pressure.

7. Use according to claim 2, wherein the moulded body (1404, 2204, 2704) has at least one passageway (1405, 2207, 2705) through which some of the industrial gas and/or another gas and/or another material can be output in the outlet direction of the outlet nozzle (1402, 2202, 2701).

8. Use according to claim 1, wherein cooling channels (3203) are assigned to the outlet nozzles (3201), which extend outside of the outlet nozzles (3201) along the external contour and at least substantially perpendicular to the direction of the flow from the outlet-nozzles (3201), a coolant being conveyable through the cooling channels (3203) and the external contour of the outlet nozzles (3201) having not an axially symmetrical but an elongated cross-section the longitudinal direction of which is in the flow direction of the coolant.

9. Use according to claim 2, wherein the moulded body (3206) has at least one cooling channel (3204) passing through its connection (3301, 3302) with the material of the external contour of the outlet nozzle (3201) and through its interior.

10. Use according to claim 8, wherein, the outlet nozzle (3201) has an elongated cross-section, the moulded body (3206) has a first connection (3301) with the material of the external contour of the outlet nozzle (3201) at the one short side of the cross-section and another connection (3302) at the opposite side, the cooling channel (3204) supplying coolant to the moulded body (3206) via the first connection (3301) and discharging it via the other connection (3302).
